(19) United States
(12) Patent Application Publication
(10) Pub. No.: US 2003/0179184 A1
(43) Pub. Date: Sep. 25, 2003

(54) Fingerprint mouse with line sensor

(76) Inventors: Manfred Bromba, Munchen (DE); Rosemarie Essl, Sankt Bartholoma (AT); Stefan Kuhn, Munchen (DE); Gerhard Sobotzki, Freising (DE)

Correspondence Address: William E Vaughan, Bell Boyd & Lloyd, PO Box 1135, Chicago, IL, 60690-1135, US

(21) Appl. No.: 10/362,979

(22) PCT Filed: Aug. 22, 2001
(86) PCT No.: PCT/DE01/03204

(30) Foreign Application Priority Data
Aug. 31, 2000 (DE) 100 42 940.8

(51) Int. Cl. G09G 5/08

(52) U.S. Cl. 345/163

(57) ABSTRACT

The invention relates to a scroll mouse comprising two mouse buttons (M1, M2). Between the two mouse buttons (M1, M2), a fingerprint line sensor (ZS) is disposed that can be used to identify a user and to detect the scroll-movement of the finger of a user.

The invention relates to a scrollmouse for computer use.

A scrollmouse or a scrollwheel mouse has the advantage that the user can scroll up and down the content within a software application window without having to place the mouse pointer on the scrollbar exactly. The scrollwheel is generally arranged between the two mouse buttons.

The invention is based on the object of making the scrollmouse more convenient for the user.

The invention achieves this object by the means of the features of patent claim 1 and by means of the features of patent claim 2.

The inventive scrollmouse affords not only the inherently known mouse functions but also the opportunity to identify the user.

The “Siemens ID mouse” has not only the two mouse buttons but also a planar fingerprint sensor which can be used to identify the user.

The invention is described below with reference to an exemplary embodiment illustrated in the drawing, in which

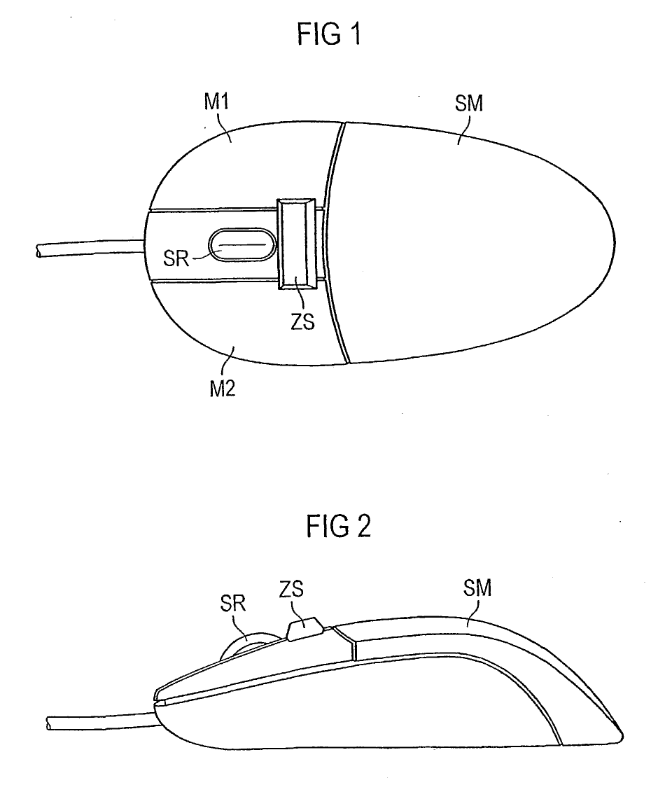

FIG. 1 shows a plan view, and

FIG. 2 shows a side view of the inventive scrollmouse.

The starting point taken is a scrollmouse SM which has a right and a left mouse button M1, M2. A scrollwheel SR can be arranged between these two mouse buttons M1 and M2. This case is shown in the drawing.

The inventive scrollmouse SM has a fingerprint line sensor ZS. This line sensor ZS is arranged in a radial direction next to the scrollwheel SR. It is of no consequence whether the line sensor ZS is arranged in front of or behind the scrollwheel SR in the direction of operation. In this context, the scrollwheel SR can be used as a finger guide, since it ensures that the finger moves in a straight line. The scrollwheel SR generally has a switch which is tripped by pressing down the wheel SR. This switch can be used to activate fingerprint recording.

A stop can be provided which allows the user to sense the start or end of the finger scan.

In another refinement of the invention, the scroll function is also adopted by the line sensor ZS or by corresponding evaluation means, preferably in the connected computer. In this context, the scrollwheel SR can be dispensed with. This case is not shown explicitly in the drawing.

The line sensor ZS is used firstly to identify the user and secondly to ascertain a movement by a finger sweeping above it. Since the line sensor ZS scans a plurality of lines, a finger movement allows the direction and speed to be derived therefrom and used to control the scroll movement.

1. A scrollmouse having two mouse buttons (M1, M2), characterized by
a fingerprint line sensor (ZS) which is arranged between the two mouse buttons (M1, M2) and can be used to identify a user and to detect the scroll movement of a user's finger.

2. A scrollmouse having two mouse buttons (M1, M2) and having a scrollwheel (SR) arranged between the two mouse buttons (M1, M2), characterized by
a fingerprint line sensor (ZS) which is arranged in a radial direction next to the scroll wheel (SR) and can be used to identify a user of a user's finger.
